(19) United States
(12) Patent Application Publication
(10) Pub. No.: US 2008/0028450 A1
(43) Pub. Date: Jan. 31, 2008

(54) Method, system and domain management center for subscribing a mobile service

(76) Inventors: Qin Zhao, Shenzhen (CN); Yongsheng Zhu, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/882,214

(22) Filed: Jul. 31, 2007

(30) Foreign Application Priority Data
Jul. 31, 2006 (CN) 200610104035.5

(51) Int. Cl. H04L 9/32

(52) U.S. Cl. 726/6

(57) ABSTRACT

A method, a system and a domain management center for subscribing a mobile service. A Domain Setter first applies for setting a domain via a domain management center and obtains a domain ID assigned to the domain by the domain management center, wherein the domain may include a plurality of devices owned by one user, or different devices of a plurality of users. The Domain Setter subscribes a related service such as CBCS service, DNS, weather forecast service and so on for the domain via a Subscription Center. It is convenient to subscribe the same service for a plurality of devices owned by one user or different devices of a plurality of users, and it may avoids to repeatedly subscribe the same service for each user or device respectively, which saves the system resources. By applying the invention, a user device may join a domain at any moment and use all services subscribed in the domain. Certainly, the user device may also leave the domain as required. The domain management center is responsible for managing the domain, which includes setting the domain, joining the domain, leaving the domain, revoking the domain, etc.

This application claims the benefit of CN Application No. 200610104035.5 filed on Jul. 31, 2006, titled “METHOD AND SYSTEM FOR SUBSCRIBING A MOBILE SERVICE”, which is incorporated herein by reference in its entirety.

### FIELD OF THE INVENTION

The present invention relates to the technical field of communications, in particular, to a method, a system and a domain management center for subscribing a mobile service.

### BACKGROUND OF THE INVENTION

With the abundant development of mobile services, the users' requirements on the diversification and individualization of information are met greatly. More and more users enjoy the convenience brought by mobile services, and continually join new services to gain new experiences. Therefore, the subscription of a mobile service and the revocation of a mobile service by a user also become a common daily round.

Meanwhile, it is extraordinarily prevalent that one user possesses a plurality of terminals. The user wants to subscribe the same service for a plurality of terminals to enjoy the same service. In such a case, the user needs to subscribe the same service for each of his/her devices. Thus, each time the user has one more device, the user needs to subscribe service for the device.

Additionally, a group manager desires that a subscribed service can be used by all users in a group. At this point, the group manager needs to subscribe the service for each of users managed by him/her. Similarly, when one user is added, the group manager needs to implement one subscription of the service for the user.

After researching, the inventor finds some disadvantages such as repeated subscription operation, inconvenient management, resource waste and poor transplantability when subscribing the same service for the different devices owned by one user or the different users in the same group in the present. The repeated subscription operation means that the same service is subscribed many times, where the differences are only the different user devices or the different group users. The inconvenient management means that each increasing/decreasing a device for one user or increasing/decreasing a user in the same group will cause an service subscription or service revocation. The resource waste is caused if the service is not revoked in time for a lost device or a user who has been out of the group, and the user who picked up the device or the user who has been out the group may continue to enjoy the service freely. The poor transplantability means that the above problems still exist while a user desires to subscribe another service or join another group when using the service subscribed by the current group.

### SUMMARY OF THE INVENTION

Therefore, the embodiments of the invention provide a method, a system and a domain management center for subscribing a mobile service to avoid repeated operations and save resources.

The technical solutions according to the embodiments of the invention includes:

A method for subscribing a mobile service includes: setting a domain and assigning a domain ID of the set domain; receiving service subscription request information from the a client, wherein the request information contains Domain Setter information, at least one domain ID and at least one ID of a service to be subscribed; and subscribing the service to be subscribed a domain indicated by the domain ID, setting and saving an index relation among the Domain Setter information, the domain ID and the ID of the subscribed service, and accomplishes the subscription operation.

A method for subscribing a mobile service includes: sending a Set Domain Request containing Domain Setter information; obtaining at least one domain ID and at least one service ID from a Set Domain Response in response to the Set Domain Request; and sending a Service Subscription Request information to subscribing a service for the at least one domain wherein the service subscription request information contains Domain Setter information, at least one domain ID and at least one service ID of a service to be subscribed.

A method for subscribing a mobile service, comprising: obtaining a domain ID related to a set domain; sending a request to Join, Leave or Revoking the domain, and receiving result information in response to the request to Join, Leave or Revoking the at least one domain, notifying the result of the Join, Leave or Revoking.

A system for subscribing a mobile service, which includes a Domain Setter, a domain management center and a Subscription Center, wherein the Domain Setter is used for sending a Set Domain Request containing Domain Setter information to the domain management center, obtaining a domain ID from a Set Domain Response received from the domain management center, and sending service subscription request information to the Subscription Center, wherein the request information contains the Domain Setter information, at least one domain ID and at least one ID of a service to be subscribed; the domain management center includes a domain-setting unit for verifying the Domain Setter according to the received Set Domain Request, and assigning the domain ID to the Domain Setter if the verification is passed; and the Subscription Center is used for receiving the service subscription request information, subscribing a service indicated by the ID of the subscribed service for a domain indicated by the domain ID, setting and saving an index relation among the Domain Setter information, the domain ID and the ID of the subscribed service, and accomplishing the subscription operation.

A domain management center, including a domain-setting unit for verifying a client according to a received Set Domain Request and assigning a domain ID to the client if the verification is passed.

In the embodiments of the invention, the Domain Setter first applies to set a domain via the domain management center and obtains the domain ID assigned to the domain by the domain management center, wherein the domain may include a plurality of devices owned by one user, or different devices of a plurality of users. The Domain Setter subscribes a related service such as Categorization-Based Content Screening (CBCS) service, Digital Newspaper Service (DNS), weather forecast and so on for the domain via the Subscription Center, so that it is convenient to subscribe the same service for a plurality of devices owned by one user or different devices of a plurality of users, and it may be avoided to repeatedly subscribe the same service for each user or each device respectively. Thus, the system resources are saved.

By applications of the embodiments of the invention, a user device may join a domain at any moment and use all the services subscribed in the domain. Certainly, the user device may leave the domain as required. The domain management center is responsible for managing the domain, which includes setting the domain, joining the domain, leaving the domain and revoking the domain, etc.

### BRIEF DESCRIPTION OF THE DRAWINGS

FIG. 1 is a schematic flow chart for subscribing a mobile service according to one embodiment of the invention;

FIG. 2 is a schematic flow chart for revoking a domain according to one embodiment of the invention;

FIG. 3 is a schematic flow chart for joining a device domain according to one embodiment of the invention;

FIG. 4 is a schematic flow chart in which a device initiatively triggers to leave a device domain according to one embodiment of the invention;

FIG. 5 is a schematic flow chart in which a domain management center initiatively triggers to leave a device domain according to one embodiment of the invention;

FIG. 6 is a schematic flow chart in which a user initiatively triggers to join a user domain according to one embodiment of the invention;

FIG. 7 is a schematic flow chart in which a user initiatively triggers to join a user domain according to another embodiment of the invention;

FIG. 8 is a schematic flow chart in which a user initiatively triggers to leave a user domain according to one embodiment of the invention;

FIG. 9 is a schematic flow chart in which a Domain Setter initiatively triggers to leave a user domain according to one embodiment of the invention;

FIG. 10 is a schematic flow chart in which a Domain Setter initiatively triggers to leave a user domain according to another embodiment of the invention;

FIG. 11 is a block diagram of components of a system for subscribing a mobile service according to one embodiment of the invention; and

FIG. 12 is a block diagram of components of a domain management center according to one embodiment of the invention.

### DETAILED DESCRIPTION OF THE EMBODIMENTS

In the embodiments of the invention, a Domain Setter applies for setting a domain, and a domain management center assigns a domain ID to the domain, wherein the domain may include devices possessed by one user or different devices possessed by a plurality of users. The Domain Setter subscribes a related service such as Categorization-Based Content Screening (CBCS) service, Digital Newspaper Service (DNS), weather forecast and so on for the domain via a Subscription Center, so that it is convenient to subscribe the same service for the devices owned by one user or the different devices of the plurality of users. A user device may join the domain at any moment and use all services subscribed in the domain. Certainly, the user device may also leave the domain as required. The domain management center is responsible for managing the domain, which includes setting the domain, joining the domain, leaving the domain, revoking the domain, etc.

In one embodiment of the invention, a domain formed by a plurality of devices possessed by one user is referred to as a device domain, and a domain formed by a plurality of different users is referred to as a user domain.

The embodiments of the invention will now be further illustrated in detail in conjunction with the drawings.

FIG. 1 is a schematic flow chart for subscribing a mobile service according to one embodiment of the invention.

Process 101: A Domain Setter sends a message of Set Domain Request to a domain management center for requesting to set a domain. Parameters in the message are shown in Table 1, which include Domain Setter information.

TABLE 1
Parameters in the message of Set Domain Request

| | Mandatory | |
|---|---|---|
| Parameter | (M)/Optional (O) | Description |
| Domain Setter Infor | M | Identifying user information |
| | | for applying to set a device |
| | | domain |
| Signature | O | Signature of a Domain Setter |
| | | on the message of Set Domain |
| | | Request |

Wherein, the Domain Setter information includes parameters shown in Table 2:

TABLE 2
Sub-parameters of the Domain Setter Info

| | | Mandatory | |
|---|---|---|---|
| | | (M)/Optional | |
| Parameter | Sub-parameter | (O) | Description |
| Domain | Setter ID | O | Identifying a user ID of a |
| Setter Info | | | user who applies for setting |
| | | | a domain |
| | Device ID | M | Identifying a user device |
| | | | which sends a message |
| | | | of Set Domain Request, |
| | | | wherein the device may |
| | | | or may not belong to |
| | | | a domain to be set |
| | Code | M | Functional Code, for |
| | | | identifying whether the |
| | | | device that sends a |
| | | | message belongs to a |
| | | | domain to be set, wherein “0” |
| | | | means that the device |
| | | | does not belong to the |
| | | | domain to be set, and |
| | | | “1” means that the |
| | | | device belongs to the |
| | | | domain. |
| | Device | O | Device Capability includes a |
| | Capability | | Manufacturer, a Type and |
| | | | so on. When Code is |
| | | | 1, the device capability may |
| | | | further include whether |
| | | | the device has the |
| | | | capability supporting XX |
| | | | service, which may be |
| | | | used in conjunction with |
| | | | the above Device ID. |

Process 102: The domain management center authenticates a client identity and determines whether setting the device domain is suitable. If the client identity is correct and setting the device domain is suitable, the domain management center assigns a domain ID to the client.

Process 103: The domain management center sends a message of Set Domain Response containing status information to the client. Parameters in the message are shown in Table 3. If the status is “Success”, the message includes the domain ID.

TABLE 3
Parameters in the message of Set Domain Response

| | Mandatory | | |
|---|---|---|---|
| | (M)/Optional (O) | | |
| | Status = | Status ≠ | |
| Parameter | Success | Success | Description |
| Status | M | M | A Status Report on the processing of the |
| | | | message of Set Domain Request |
| | | | A domain ID assigned by the domain |
| Domain ID | M | — | management center, serving other |
| | | | subsequent devices for joining |
| | | | the domain |
| Signature | O | — | A signature of the domain management |
| | | | center on the message of Set Domain |
| | | | Response |

Thus, the Domain Setter sets a domain and obtains the domain ID of the set domain.

Process 104: The Domain Setter sends a message of Subscription Request to the Subscription Center, wherein the request information includes the Domain Setter information, at least one domain ID and at least one service ID of a service to be subscribed.

The Domain Setter information contains the Setter ID such as name, etc., the Device ID of the Domain Setter such as mobile phone number or International Mobile Subscriber Identity (IMSI) number, etc., and Device Capability of the Domain Setter, wherein the Setter ID and Device Capability of the Domain Setter are optional. The domain ID is used for indicating for which domain a mobile service is subscribed. The service ID of a service to be subscribed is used for indicating which of mobile services need to be subscribed, such as CBCS service, DNS, weather forecast and so on.

If the message contains a plurality of domain IDs and a plurality of service IDs of services to be subscribed, there may be a one-to-one relation, one-to-many relation, many-to-many relation or many-to-one relation among them.

Process 105: The Subscription Center authenticates the Domain Setter and the domain ID. In other words, the Subscription Center verifies the Setter ID, whether the Domain Setter has a privilege for subscribing, the domain exists, and so on. If the Domain Setter and the domain ID are correct, a service indicated by the service ID of the service to be subscribed is subscribed for a domain indicated by the domain ID, and an index relation among the Domain Setter information, the domain ID and the service ID of the service to be subscribed is set and saved. Thus, the service subscription is accomplished. In the process, the authentication operation is optional.

Process 106: The Subscription Center sends a message of service subscription response containing status information to the Domain Setter to notify the Domain Setter of its subscription status.

Thus, the mobile service subscription is accomplished.

There is not a strict time limitation between Process 103 and Process 104. In other words, Process 104 may be performed immediately after Process 103, or Process 104 may be performed after a period of time.

The above Subscription Center and the domain management center are both logic entities, which may be on the same device or on different physical devices.

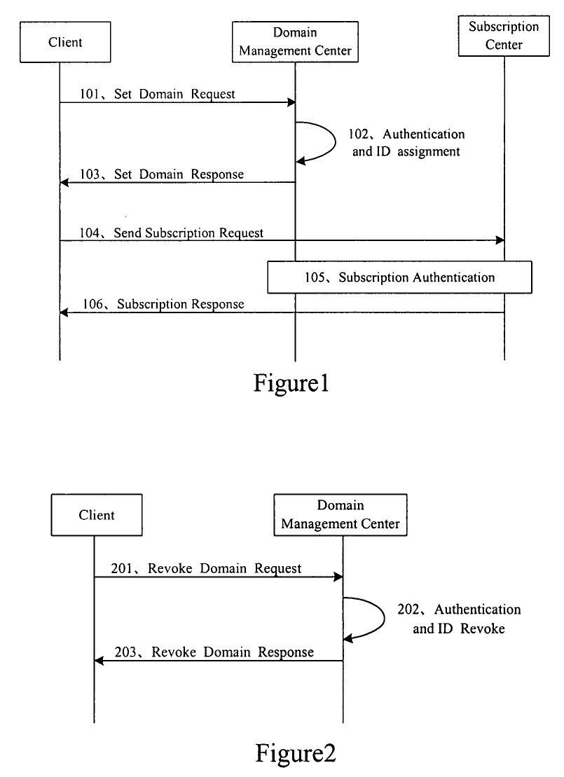

For a set domain, it may be revoked as required, a specific flow of which is shown in FIG. 2.

FIG. 2 is a schematic flow chart for revoking a domain according to one embodiment of the invention.

Process 201: A client sends a message of Revoke Domain Request to a domain management center for requesting to revoke a domain. The message contains a device ID and a domain ID in client information.

Here, the client that sends the request may be a Domain Setter or any other clients.

Process 202: The domain management center performs an authentication operation, i.e. the domain management center verifies whether the domain exists and whether the client which sends the Revoke Domain Request has a privilege for revoking the domain. If the domain exists and the client which sends the Revoke Domain Request has a privilege for revoking the domain, the domain management center revokes the domain and deletes index information related to the revoked domain.

The above process for verifying whether the client that sends the Revoke Domain Request has the privilege for revoking the domain is as follows: first of all, the domain management center verifies whether the client that sends the Revoke Domain Request is the Domain Setter. If the client is the Domain Setter, the Domain Setter has the privilege; otherwise, the domain management center verifies whether the client that sends the Revoke Domain Request and the Domain Setter both pertain to the same user. If they pertain to the same user, the client has the privilege; otherwise, the client that sends the Revoke Domain Request has not the privilege.

Process 203: The domain management center sends a message of Revoke Domain Response containing status information to the client.

Thus, the flow for revoking the domain is accomplished.

The above flows for setting a domain and revoking a domain are suitable for both the device domain and the user domain. The only difference lies in that, if a device domain is set or revoked, the above domain ID will be a domain ID of the device domain; and if a user domain is set or revoked, the above domain ID will be a domain ID of the user domain.

The flows for joining and leaving a domain will now be illustrated. For convenience, the flows for joining/leaving a device domain and the flows for joining/leaving a user domain are illustrated respectively.

Joining a Device Domain

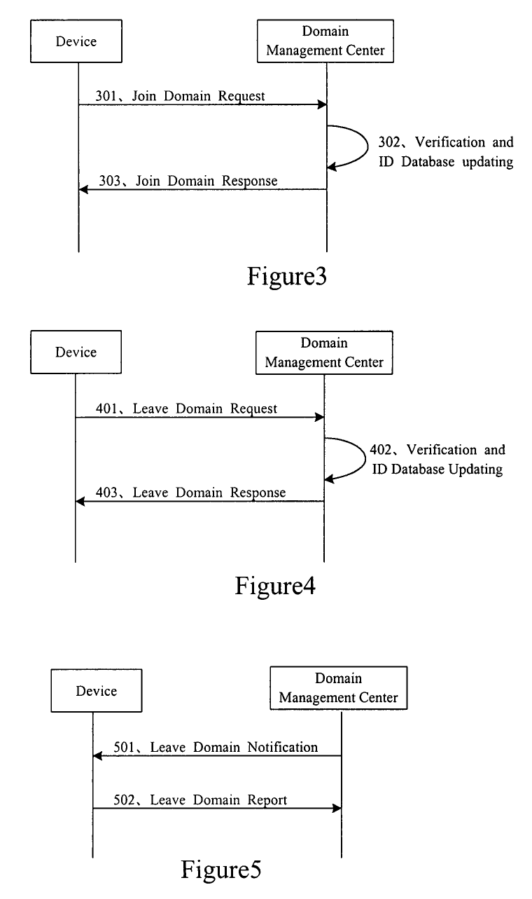

If a user purchases a new device or wants other devices to use all subscribed services in a domain, the new device must join the domain. The flow for joining the device domain is shown in FIG. 3.

Process 301: A device to join sends a message of Join Domain Request to a domain management center for requesting to join a certain device domain. The message contains information of the device to join, such as IMSI number or mobile phone number, etc., and a device domain ID.

The device for sending the above message of Join Domain Request may be the device to join the domain currently in Process 301, a device of the Domain Setter, or other devices in the domain except for the Domain Setter. If it is the other devices, the message of Join Domain Request further needs to contain a device ID of the device that sends the message of Join Domain Request. It should be noted that the device to join and/or the above device of the Domain Setter may be the same device or different devices.

Here, all the above devices that can send the message of Join Domain Request are generally referred to as client-side device. In this embodiment, the message of Join Domain Request is sent by the client-side device initiatively. However, it may also be triggered by the domain management center and sent by the client-side device passively.

Process 302: The domain management center authenticates the device. In other words, the domain management center verifies whether the device domain is valid and whether the device is allowed to join the domain. If the device domain is valid and the device is allowed to join the domain, the domain management center updates its database according to the device domain ID. In other words, the device ID of the device to join is added to a device list contained in the domain.

A configuration file may be set in the domain management center to save the following parameters. When the number of devices that join a domain is greater than the maximum number of devices Max_DeviceNum, no more device will be allowed to join the domain. The domain management center may determine whether a device is permitted to join the domain according to this rule.

Process 303: The domain management center sends a message of Join Domain Response containing status information to the above device. If the status is “Success”, the message further contains device domain information, such as the expiration date of the domain, etc.

Additionally, if the device to join and the device of the Domain Setter are different devices, the domain management center may further notify the device to join and/or the device of the Domain Setter of result information of whether to join.

In addition, the domain management center may further notify the Subscription Center of the result of whether to join.

Leaving a Device Domain

If a user wants to make a certain device stop using a domain service, a certain device of a user is lost or damaged, a user changes a device, or a domain management center will no longer provide services for a certain device due to a security problem in the device, the original device must leave a domain. There are two ways to trigger a device to leave a domain: a client-side device initiatively requests to leave a domain; and the client-side device is passively triggered to leave a domain, i.e., the domain management center triggers initiatively.

One embodiment of the method for initiatively triggering to leave a device domain by the client-side device is shown in FIG. 4.

Process 401: A device sends a message of Leave Domain Request to the domain management center for requesting to leave a certain device domain. The message contains information of a device to leave the domain, such as IMSI number, mobile phone number, etc. The request message further contains a device domain ID.

If the device that sends the message is not the device to leave the domain, the above message of Leave Domain Request must further contain information of the device sending the message of Leave Domain Request. For example, a user requests to leave a domain for a lost or damaged device by using his/her own device. In other words, the device that sends the message of Leave Domain Request may be the device that currently needs to leave, the above device of the Domain Setter, or other devices in the domain except for the Domain Setter. It should be noted that the device that currently needs to leave and the above device of the Domain Setter may be the same physical device or different physical devices.

Process 402: The domain management center authenticates the device, and verifies whether the device domain exists and whether the device may leave the domain. If the device is suitable, the device domain exists and the device may leave the domain, the domain management center updates its database according to the device domain ID, i.e. the device ID of the device to leave is deleted from a device list contained in the domain.

Process 403: The domain management center sends a message of Leave Domain Response containing status information to the device.

In addition, if the leaving request is sent by the device which currently needs to leave, the domain management center may further send a notice to the Domain Setter for notifying that the device is to leave.

One embodiment of the method for initiatively triggering to leave a device domain by a domain management center is shown in FIG. 5.

Process 501: A domain management center sends a message of Leave Domain Notification to a device for requesting a certain device or some devices to leave a domain. The message contains a device domain ID and a device ID of a device to leave.

Process 502: The device sends a message of Leave Domain Report to the domain management center for reporting that various processes have been performed for leaving the domain.

In the processes shown in FIG. 5, the domain management center may update a local domain ID database before Process 501, i.e. before notifying the device to leave the domain. Alternately, the local domain ID database may be updated after Process 502, i.e. after the device reports that the processes for leaving the domain have been implemented.

When the domain management center initiatively triggers for leaving the device domain, there is further another method. In other words, the domain management center sends a message of Trigger to a device that is required to leave for requesting the device to initiate a flow for leaving a certain device domain, i.e. the device is requested to initiate the flow shown in FIG. 4. The message of Trigger contains a device domain ID and a device ID of the device which is required to leave. At this point, The message of Leave Domain Request in Process 401 as shown in FIG. 4 may further contains an optional extension item, which is mainly used for notifying the domain management center that a certain device no longer belongs to a certain device domain, so that the domain management center can delete association information between the device and the domain from the database. Therefore, the following similar situations are prevented. For example, a certain device has sent a message of Leave Domain Request previously and at the same time has deleted association information between the device and a domain stored in the device, i.e. the certain device has left the domain. However, the domain management center does not delete the association information between the device and the domain because the domain management center may not receive the previously sent message of Leave Domain Request. Thus, the domain management center may still send a new message of Trigger for leaving the domain to the device.

Additionally, if the device to leave and the device of the Domain Setter are different devices, the domain management center may also notify the device to leave and/or the device of the Domain Setter of result information of whether to delete.

For all of the above cases for leaving a device domain, the domain management center may further notify the Subscription Center of a result of whether to leave.

Joining a User Domain

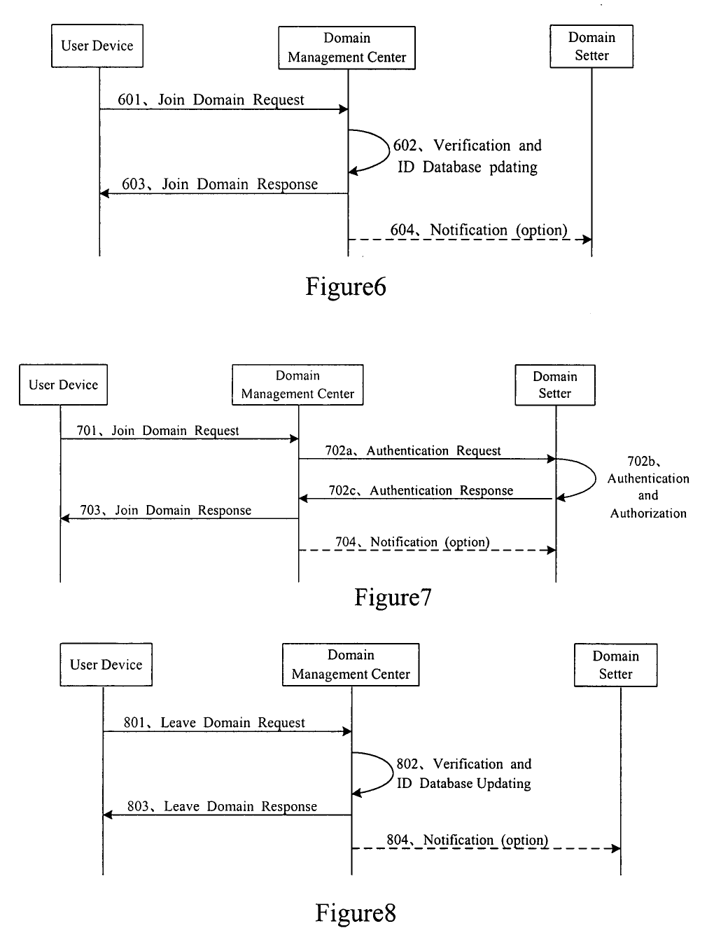

When a new user joins a group and needs to use subscribed mobile services of the group, for example, when a new employee joins an enterprise, or a new student is enrolled in a school etc., the operation of joining a user domain needs to be performed. This flow is shown in FIG. 6.

Process 601: A device held by a user to join sends a message of Join Domain Request to a domain management center for requesting to join a certain user domain. The message contains user information of a user to join, a user domain ID and a certificate for authorizing a user to join a domain by a Domain Setter.

The user Information of the user to join may be Information of a certain device held by user, such as IMSI number or mobile phone number. It may also be information of a device domain in which the user currently exists, such as device domain ID.

The Domain Setter authorizes a certificate for allowing a user to join a domain, which is an optional parameter. The certificate may be a password for joining a domain, which is set by the Domain Setter, a signature of the Domain Setter, or other certificates. If there is not the certificate parameter, the domain management center may adopt the following ways to process.

A Default Policy is used to process, which may be Allowing To Join or Rejecting To Join, or a method as shown in FIG. 7 is adopted for certification processing.

Additionally, the device for sending the above message of Join Domain Request may be the device held by the user to join the domain currently, the above device of the Domain Setter, or other devices in the domain except for the Domain Setter. If it is the other devices, the message of Join Domain Request further needs to contain a device ID of the device that sends the message of Join Domain Request. It should be noted that the device to join the domain currently and the above device of the Domain Setter may be the same device or different devices. Similarly, all the above devices that can send a message of Join Domain Request here are generally referred to as a client-side device. In the embodiment, the message of Join Domain Request is initiatively sent by the client-side device. However, it may also be triggered by the domain management center and then sent by the client-side device passively.

Process 602: The domain management center authenticates a user identity, and verifies whether the user domain is valid and whether the user has a privilege for joining in the user domain. If the user identity is correct, the user domain is valid and the user has a privilege for joining in the user domain, the domain management center updates its database according to the user domain ID, i.e. the domain management center adds the device ID of the device held by the user to join or the domain ID of the device held by the user to join to a device list contained in the user domain.

A configuration file may be set in the domain management center to save the following parameters. When the number of users who join a domain is greater than Max_UserNum, no more users will be allowed to join the domain. The domain management center may determine whether a user is permitted to join a domain according to this rule.

Process 603: The domain management center sends a message of Join Domain Response containing status information to the device held by the user to join. If the status is “Success”, the message contains user domain information such as an expiration date of the domain, etc., and the process proceeds to Process 604; otherwise, the process ends.

Process 604: The domain management center sends a message of Push Notification to the Domain Setter for notifying that the certain user joins the user domain which is set by the Domain Setter. The message contains the user information and user domain ID. The process is optional.

Additionally, if the device held by the user to join and the device of the Domain Setter are different devices, the domain management center may further notify the device held by the user to join and/or the device of the Domain Setter of result information of whether to join.

In addition, the domain management center may further notify the Subscription Center of the result of whether to join.

FIG. 7 shows another flow for joining a user domain, which is different from the flow shown in FIG. 6 in that a message of Join Domain Request in Process 701 does not contain the parameter of the certificate for authorizing a user to join a domain by the Domain Setter. Referring to FIG. 7, after receiving the request, the domain management center sends a message of Authentication Request to the Domain Setter for requesting to verify whether the user to join has a privilege for joining the user domain. The domain management center determines whether the user sending the request has the privilege for joining the user domain according to a message of Success Authentication Response received from the Domain Setter. After the authentication is successful, the domain management center updates its database, i.e. the device ID of the device held by the user to join or the domain ID of the device held by the user to join is added to a device list contained in the user domain. In other words, Process 602 is replaced by Process 702a to Process 702c.

Leave a User Domain

If a user leaves a group, e.g. dimission or graduation etc., a Domain Setter considers that a user should no longer use its subscribed service, or a domain management center considers that a user device is insecure and thus does not want to further provide a service to the user, and the user must leave the user domain. There are two ways for triggering a user to leave a domain, i.e. a user initiatively leaves a domain, and a user passively leaves the domain.

The method for a user to initiatively leave a domain includes the following processes, and one embodiment of the flow is as shown in FIG. 8.

Process 801: A device held by a user sends a message of Leave Domain Request to a domain management center for requesting to leave a certain user domain. The message contains user information of a user to leave the domain, a user domain ID, and a certificate for authorizing the user to leave the domain by the Domain Setter.

User information in the message of Leave Domain Request and the user information contained in the message of Join Domain Request are consistent with each other, i.e. it must be device information here if it was the device information originally, and it must be device domain information here if it was the device domain information originally.

The certificate for authorizing the user to leave the domain by the Domain Setter is optional. If it must be allowed by the Domain Setter that a user leaves a domain for some services, the user also needs to submit the certificate for authorizing the user to leave the domain by the Domain Setter. The certificate may be a password for leaving a domain, which is set by the Domain Setter, a signature of the Domain Setter or other certificates.

Process 802: The domain management center authenticates a user identity, and verifies whether the user domain exists. If the user identity is correct and the user domain exists, the domain management center updates its database according to the user domain ID, i.e. a device ID of a device held by the user to leave or a domain ID of the device held by the user to leave is deleted from a device list contained in the domain.

For a service for which a user can only leave after being permitted by the Domain Setter, in this process, a procedure for verifying whether the user may leave the user domain is further needed. There are two ways for the verification, i.e. whether the user is allowed to leave the domain is verified according to the certificate for authorizing the user to leave the domain by the Domain Setter in the message of Leave Domain Request, and whether the user is allowed to leave the domain is verified by an interaction between the domain management center and the Domain Setter, processes of which are the same as Processes 702a to 702c in FIG. 7.

Process 803: The domain management center sends a message of Leave Domain Response containing status information to the user. If the status information is “Success”, the process may proceed to Process 804; otherwise, the process ends.

Process 804: The domain management center sends a message of Push Notification to the Domain Setter for notifying that a certain user leaves the user domain which is set by the Domain Setter. The message contains the user information and the user domain ID. The process is optional.

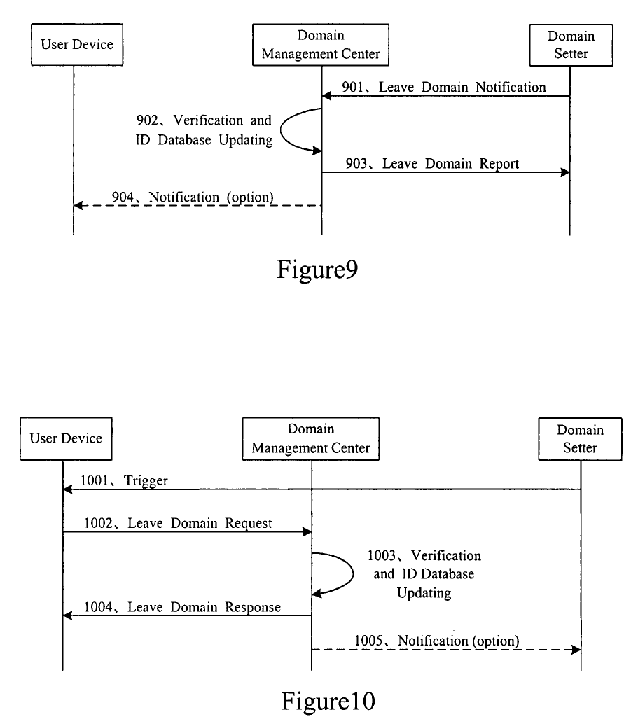

When a Domain Setter does not want a certain user to use its subscribed service, the Domain Setter may notify a domain management center to revoke a privilege for using the domain service by the user. In other words, the Domain Setter notifies the domain management center to make the user leave a domain. At this point, the user leaves the domain passively. The process is as shown in FIG. 9.

Process 901: The Domain Setter sends a message of Leave Domain Notification to the domain management center for notifying it to revoke a privilege for using a domain by a certain user. The message contains Domain Setter information, a user domain ID and user information of the user whose privilege is to be revoked. The user information may be user device information or user device domain information.

Process 902: The domain management center authenticates an identity of the Domain Setter, and verifies whether the user domain exists. If the identity of the Domain Setter is correct and the user domain exists, the domain management center updates its database according to the user domain ID, i.e. a device ID of a device held by the user to leave or a device domain ID of a device held by the user to leave is deleted from a device list contained in the domain.

Process 903: The domain management center sends a message of Leave Domain Report containing status information to the Domain Setter. If the status information is “Success”, the process may proceed to Process 904; otherwise, the process ends.

Process 904: The domain management center sends a message of Push Notification to the user for notifying the user that the domain management center has revoked the user's privilege for using the user domain. The process is optional.

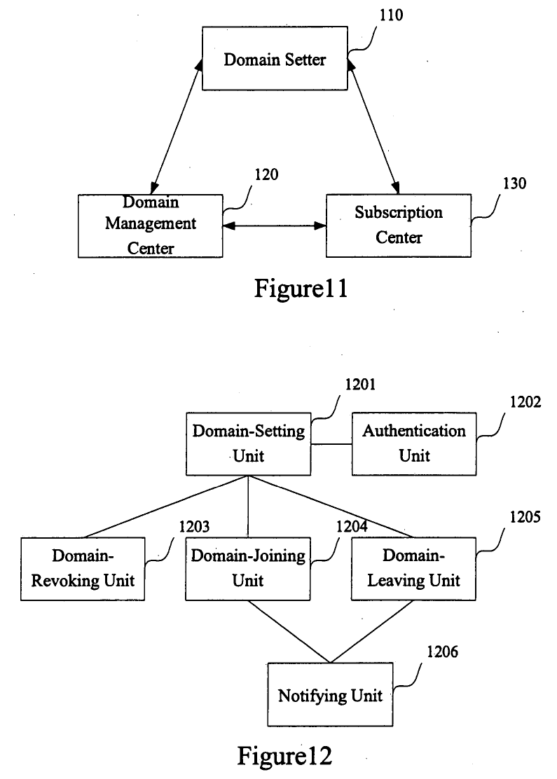

There is another implementation way for the process in which a user leaves passively, and the process is initiated by the client initiatively, as shown in FIG. 10.

Process 1001: A Domain Setter sends a message of Trigger to a device held by the user to leave for requesting the device to initiate a process of leaving a certain user domain. The message of Trigger contains a user domain ID and a signature of the Domain Setter on the message of Trigger.

Process 1002: The device held by the user to leave sends a message of Leave Domain Request to the domain management center for requesting to leave the certain user domain. The message contains information of the user to leave the domain, the user domain ID, an extension item and the signature of the Domain Setter on the message of Trigger in Process 1001.

The extension item is an optional parameter, which is mainly used for notifying the domain management center and/or the Domain Setter that the certain device does not belong to the certain device domain, so that the domain management center and/or the Domain Setter can delete association information between the device and the domain from the database. Thus, the following situations are prevented. For example, neither of the domain management center and the Domain Setter knows that the certain device has left the certain domain, so the device held by the user may still receive a new message of Trigger for leaving the domain.

The signature of the Domain Setter on the message of Trigger is also an optional parameter. The signature may be used as a certificate for authorizing the user to leave the domain by the Domain Setter to meet such situation that in some services, it is necessary that a user must be permitted by the Domain Setter when he/she needs to leave a domain.

Process 1003: The domain management center authenticates an identity of the user, and verifies whether the user domain exists. If the identity of the user is correct and the user domain exists, the domain management center updates its database according to the user domain ID, i.e. a device ID of the device held by the user to leave or a domain ID of the device held by the user to leave is deleted from a device list contained in the domain.

Process 1004: The domain management center sends a message of Leave Domain Response containing status information to a user client. If the status information is “Success”, the process proceeds to Process 1005; otherwise, the process ends.

Process 1005: The domain management center sends a message of Push Notification to the Domain Setter for notifying that the user has left the user domain which is set by the domain management center. The message contains user information and the user domain ID. The process is optional.

Additionally, for the embodiments described in FIGS. 8, 9 and 10, if the device held by the user to leave and the device of the Domain Setter are different devices, the domain management center may further notify the device held by the user to leave and/or the device of the Domain Setter of result information of whether to delete.

The domain management center may further notify the Subscription Center of a result of whether to leave.

Additionally, it should be noted that for the case in which a user leaves passively, the flow may be initiated by the domain management center initiatively, which is similar to that of FIG. 10. The difference is in that a message of Trigger is sent by the domain management center, rather than by the Domain Setter, and the rest of the flow are the same as those of FIG. 10. Thus, this will not be described again here.

An embodiment of the invention further discloses a system for subscribing a mobile service as shown in FIG. 11, which includes Domain Setter 110, domain management center 120 and Subscription Center 130.

Domain Setter 110 is used for sending a Set Domain Request containing Domain Setter information to domain management center 120, obtaining a domain ID according to a Set Domain Response received from domain management center 120, and sending a service subscription request information, which contains Domain Setter information, at least one domain ID and at least one service ID of a service to be subscribed, to Subscription Center 130. If a plurality of domain IDs and a plurality of service IDs of services to be subscribed are contained in the service subscription request information, there may be a one-to-one relation, one-to-many relation, many-to-many relation or many-to-one relation between the plurality of domain IDs and the plurality of service IDs of the services to be subscribed.

Domain management center 120 includes a domain-setting unit, for verifying the Domain Setter according to the received Set Domain Request, and assigning a domain ID to the Domain Setter if the verification is passed.

Subscription Center 130 is used for receiving the service subscription request information, subscribing a service indicated by the service ID of the service to be subscribed for a domain indicated by the domain ID, setting up and saving an index relation among the information of Domain Setter 110, the domain ID and the service ID of the service to be. subscribed, and accomplishing the subscription operation. After receiving the service subscription request information, Subscription Center 130 is further used for authenticating Domain Setter 110 and the domain ID. After the authentication is passed, the subsequent processes will be performed.

As shown in FIG. 2, it is a block diagram of components of domain management center 120 according to an embodiment of the invention. Domain management center 120 at least includes domain-setting unit 1201, for verifying the client according to the received Set Domain Request, and assigning a domain ID to the client after the verification is passed. Domain management center 120 may further include authentication unit 1202, for authenticating the Domain Setter and the domain ID.

The above domain management center 120 further includes domain-revoking unit 1203, for receiving a Revoke Domain Request containing a domain ID, verifying whether a domain to be revoked exists and whether a client that sends the Revoke Domain Request has a privilege for revoking the domain, and revoking the domain indicated by the domain ID after the verification is passed. The domain revoking unit is further used for deleting index information related to the revoked domain. The process for verifying whether the client that sends the Revoke Domain Request has the privilege for revoking the domain has been described in the above flow of the method. Thus, it will not be described again here.

The above domain management center 120 further includes domain-joining unit 1204 for receiving a Join Domain Request which contains a device ID of a device to join and a domain ID of a domain to be joined from a client-side device, verifying whether the domain is valid and whether the device is allowed to join the domain, and adding the device ID of the device to join to a device list contained in the domain when the domain is valid and the device is allowed to join the domain.

The above domain management center 120 further includes domain-leaving unit 1205, for receiving a Leave Domain Request containing a device ID of a device to leave and a domain ID from a client-side device, verifying whether the domain is valid, and deleting the device ID of the device to leave from a device list contained in the domain after the verification is passed.

The above client-side device is the device to join/leave, the device of the Domain Setter, or other devices in the domain except for the Domain Setter. The device to join/leave and the device of the Domain Setter may be the same device or different devices.

The above domain management center 120 further includes notifying unit 1206, for notifying the Subscription Center of a result of whether to join or a result whether to delete.

The above domain may be a device domain or a user domain.

When the above domain is the user domain, the device ID of the device to join/leave may be an ID of a certain specific device, or an ID of a certain device domain.

The above Subscription Center 130 and domain management center 120 may be on the same physical entity or on different physical entities.

The method for subscribing according to the embodiments of the invention will be further described in conjunction with the following examples.

A CBCS service is the main content researched by Open Mobile Alliance (OMA) CBCS workgroup, which aims to protect a user from being bothered by illegal information, junk mails and mobile phone virus, and to provide an individualized protection service for users. For example, parents require to protect their children from influence of bad contents such as eroticism, violence, gambling and so on when they use wireless terminals, and employers want their employees not to surf on a web using a mobile phone or deal with affairs apart from their work during working hours.

It is supposed that Alice is Bob and Cindy's mother, Alice's mobile phone number is 1303001926, Bob's mobile phone number is 1389621674, and Cindy has two mobile phones whose numbers are 13446397562 and 13301257568 respectively.

### EMBODIMENT 1

### Subscription of a CBCS Service for a Device Domain

In this example, Cindy is ready to subscribe the CBCS service for herself, and requires to filter all information from www.ebye.com. She first sets a device domain, activates the CBCS service, and finally customizes filtering rules for herself.

Process 1: Cindy sends a message of Set Domain Request to a domain management center by a device with the number of 13446397562, for requesting to set a device domain. Parameters in the message are shown in Table 1. The Domain Setter information is shown in Table 2. “Setter ID” may be Cindy from Hilton Street 4 California, USA, “Device ID” may be 13446397562, and “Code” is 1.

The domain management center returns a message of Set Domain Response. Parameters in the message are shown in Table 3. It is assumed that “Status” is Success, and “Domain ID” is 123.

Thus, Cindy has set the device domain.

Process 2: Cindy sends a message of CBCS Provisioning Request to the Subscription Center using the above device. Parameters in the message are shown in Table 4.

TABLE 4
The parameters in the message of CBCS Provisioning Request

| | Mandatory | |
|---|---|---|
| Parameter | (M)/Optional (O) | Description |
| Subscriber Info | M | Identifying information of a CBCS |
| | | service subscriber |
| Domain Info List | M | Identifying a domain |
| | | information list which includes |
| | | one to more Domain Info. |
| | | (for meeting the requirements |
| | | of subscribing the CBCS service |
| | | for a plurality of domains). |
| | | Wherein the Domain Info. |
| | | contains a Domain ID. |
| Signature | O | The signature of a subscriber |
| | | on the message of CBCS |
| | | Provisioning Request |

Here, “Subscriber Info” is information related to Cindy, which may contains “Subscriber ID” such as Cindy from Hilton Street 4 California, USA, and “Device ID” such as 13446397562.

Because Cindy only subscribes the CBCS service for device domain 123, “Domain Info List” just includes one “Domain Info”, i.e. the information related to domain 123 which is set by Cindy. For example, “Domain ID” is 123.

The Subscription Center assigns a CBCS ID for Cindy, which is contained in the message of CBCS Provisioning Response and returned to Cindy.

Process 3: Cindy customizes the user filtering rule by using the CBCS ID in the Subscription Center, i.e. all the information from www.ebye.com will be filtered out.

Thus, the CBCS service is successfully subscribed device domain 123.

If Cindy also wants the other of her two mobile phones, 13301257568, to use the CBCS service in device domain 123, the mobile phone, 13301257568, must join the domain. The mobile phone 13301257568 sends a message of Join Domain Request for requesting to join the device domain 123. Parameters in the message are shown in Table 5:

TABLE 5
The parameters in the message of Join Domain Request

| | Mandatory | |
|---|---|---|
| Parameter | (M)/Optional (O) | Description |
| Joiner Info | M | Identifying information of the device |
| | | to join a domain. For a Joiner of a |
| | | device domain, the information is a |
| | | Device ID of a device to join the |
| | | domain. For a Joiner of a user |
| | | domain, the information may be the |
| | | Device ID or a Domain ID. |
| Domain ID | M | Identifying a domain to be joined |
| Authorization | O | Authorizing a certificate for |
| | | allowing a Joiner to join a domain |
| Signature | O | Signature of a device on the |
| | | message of Join Domain Request |

Because of joining the device domain, “Joiner Info” is “Device ID”, and its value may be 13301257568. “Domain ID” is 123.

After the domain management center authenticates the Domain ID, a message of Join Domain Response is returned. Parameters in the message are shown in Table 6.

If the Status is “Success”, the message needs to contain a parameter “Domain Info”. For example, an expiration date of device domain 123 is 1 year.

TABLE 6
The parameters in the message of Join Domain Response

| | Mandatory (M)/ | | |
|---|---|---|---|
| | Optional (O) | | |
| | Status = | Status ≠ | |
| Parameter | Success | Success | Description |
| Status | M | M | A Status Report for processing the |
| | | | message of Join Domain Request |
| Domain Info | M | — | Domain Information, such as an |
| | | | expiration date of a domain, etc. |
| Signature | O | — | A signature of the domain management |
| | | | center on the message of Join Domain |
| | | | Response |

### EMBODIMENT 2

### A Subscription of a CBCS Service for a User Domain

Alice is ready to subscribe the CBCS service for her children Bob and Cindy, and requires to filter out contents including eroticism, violence and gambling. She first sets a user domain in a domain management center, activates the CBCS service, and finally customs a filtering rule for her children.

Process 1: Alice sends a message of Set Domain Request to the domain management center using her mobile phone, for requesting to set a user domain. Parameters in the message are shown in Table 1. The Domain Setter information is shown in Table 2. Here, “Setter ID” may be Alice from Hilton Street 4 California, USA and mother of Bob and Cindy, “Device ID” may be 1303001926, and “Code” is 0.

The domain management center returns a message of Set Domain Response. Parameters in the message are shown in Table 3. It is assumed that “Status” is Success, and “Domain ID” is 014.

Process 2: Alice sends a message of CBCS Provisioning Request to a Subscription Center by using her mobile phone, for requesting to activate the CBCS service for the user domain set by her or her mobile phone. Parameters in the message are shown in Table 4.

Here, “Subscriber Info” is information related to Alice, which may contains “Subscriber ID” such as Alice from Hilton Street 4 California, USA and mother of Bob and Cindy, and “Device ID” such as 1303001926.

Because Alice only subscribes the CBCS service for user domain 014, “Domain Info List” just includes one “Domain Info”, i.e. information related to domain 014 which is set by Alice. For example, “Domain ID” is 014.

The Subscription Center assigns a CBCS ID for Alice, which is contained in a message of CBCS Provisioning Response and returned to Alice.

Process 3: Alice sets a user filtering rule by using the CBCS ID in the Subscription Center, i.e. contents containing eroticism, violence and gambling are filtered out.

Thus, the CBCS service has been successfully subscribed user domain 014.

If Bob and Cindy want to join user domain 014, Bob and Cindy will send a message of Join Domain Request to the domain management center respectively. Parameters in the message are as shown in Table 5.

Since Bob only has one mobile phone, “Joiner Info” is “Device ID”, which may be 1389621674. Since Cindy has set a device domain 123, “Joiner Info” may be “Domain ID”, i.e. 123.

The “Domain ID” of the domain to be joined by Bob and Cindy is 014. A certificate for authorizing them to join the domain by Alice may be a password such as “SESAME OPENING THE DOOR”.

After the domain management center authenticates the Domain ID, a message of Join Domain Response is returned. Parameters in the message are as shown in Table 6. If the Status is “Success”, the message must contain a parameter “Domain Info”. For example, an expiration date of user domain 014 is half a year.

In the embodiments of the invention, a Domain Setter first applies for setting a domain via a domain management center and obtains a domain ID assigned to the domain by the domain management center. The domain may include a plurality of devices of a user, or different devices of a plurality of users. The Domain Setter subscribes a related service for the domain via a Subscription Center, such as CBCS, DNS, weather forecast service, etc. Thus, it is convenient to subscribe the same service for a plurality of devices of a user or different devices of a plurality of users, and it may be avoided to repeatedly subscribe the same service for each user or device respectively. Therefore, the system resources are saved.

By applying the embodiments of the invention, a user device may join a domain at any moment and use all services subscribed in the domain. Certainly, the user device may also leave the domain as required. The domain management center is responsible for managing the domain, which includes setting the domain, joining the domain, leaving the domain and revoking the domain, etc.

Additional advantages and modifications will readily occur to those skilled in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

1. A method for subscribing a mobile service, comprising:
setting a domain and assigning a domain ID of the domain;
receiving service subscription request information from a client, wherein the request information contains Domain Setter information, at least one domain ID and at least one ID of a service to be subscribed; and
subscribing, a service indicated by the at least one ID of the service to be subscribed for a domain indicated by the at least one domain ID, setting and saving an index relation among the Domain Setter information, the domain ID and the ID of the service to be subscribed, and accomplishing the subscription operation.

2. The method of claim 1, further comprises: authenticating the Domain Setter and the domain ID, and performing the subscribing after the authentication is passed.

3. The method of claim 1, the setting the domain and assigning the domain ID of the set domain comprises:
receiving, a Set Domain Request from a Domain Setter wherein the request contains the Domain Setter information; and
verifying the Domain Setter, and assigning the domain ID to the Domain Setter after the verification is passed.

4. The method of claim 3, further comprising:
receiving a Revoke Domain Request from a client which contains a domain ID;
verifying whether a domain to be revoked exists and whether the client which sends the Revoke Domain Request has a privilege for revoking the domain; and
revoking the domain indicated by the domain ID when the domain to be revoked exists and the client which sends the Revoke Domain Request has the privilege for revoking the domain.

5. The method of claim 4, wherein the verifying whether the client which sends the Revoke Domain Request has the privilege for revoking the domain comprises:
verifying whether the client which sends the Revoke Domain Request is the Domain Setter; if the client is the Domain Setter, the client has the privilege; if the client is not the Domain Setter, further verifying whether the client which sends the Revoke Domain Request and the Domain Setter pertain to the same user; if they pertain to the same user, the client has the privilege; otherwise, the client which sends the Revoke Domain Request has no privilege.

6. The method of claim 4, further comprising:
deleting index information related to the revoked domain.

7. The method of claim 4, further comprising:
receiving a Join Domain Request from a client-side device which contains a device ID of the device to join and a domain ID to indicate the domain to be joined,;
verifying whether the domain to be joined is valid and the device is allowed to join; and
adding the device ID to a device list contained in the domain when the domain is valid and the device is allowed to join.

8. The method of claim 7, further comprising:
receiving a Leave Domain Request from a client-side device which contains a device ID of the device to leave and the domain ID to indicate the domain to be leaved;
verifying whether the domain is valid, and
deleting the device ID from the device list contained in the domain when the domain is valid.

9. The method of claim 8, wherein when the domain is valid, the method further comprises:
verifying whether the device to leave is allowed to leave; if the device is allowed to leave, deleting the device ID from a device list contained in the domain; otherwise, declining to delete the device ID.

10. The method of claim 9, wherein the Leave Domain Request is sent by the client-side device initiatively, by a domain management center initiatively, or by the client-side device passively according to a trigger request received from the domain management center.

11. The method of claim 8, wherein:
if the Join/Leave Domain Request is sent by a client-side device to join/leave the domain and the device to join/leave and the device of the Domain Setter are different devices, the method further comprises:
notifying, the device to join/leave of result information of whether to join/delete; or notifying the device to join/leave and/or the device of the Domain Setter of the result information of whether to join/delete; or
if the join/leave domain request is sent by a client-side device of the Domain Setter, and the device to join/leave and the device of the Domain Setter are different devices, the method further comprises:
notifying the device of the Domain Setter of the result information of whether to join/delete; or notifying the device to join/leave and/or the device of the Domain Setter of the result information of whether to join/delete.

12. The method of claim 8, further comprising: notifying, by the domain management center, the Subscription Center of a result of whether to join/delete.

13. The method of claim 8, wherein the domain is a device domain or a user domain, when the domain is the user domain, the device ID of the device to join/leave is an ID of a certain specific device or an ID of a certain device domain.

14. The method according to claim 1, wherein if a plurality of domain IDs and a plurality of service IDs of services to be subscribed are contained in the subscription request information, a one-to-one relation, one-to-many relation, many-to-many relation, or many-to-one relation exists between the plurality of domain IDs and the plurality of service IDs of services to be subscribed.

15. The method of claim 1, wherein a service indicated by the service ID of the service to be subscribed comprises: Categorization-Based Content Screening service, Digital Newspaper Service or weather forecast service.

16. A method for subscribing a mobile service, comprising:
sending a Set Domain Request containing Domain Setter information;
obtaining at least one domain ID and at least one service ID from a Set Domain Response in response to the Set Domain Request; and
sending a Service Subscription Request information to subscribing a service for the at least one domain wherein the service subscription request information contains Domain Setter information, at least one domain ID and at least one service ID of a service to be subscribed.

17. The method of claim 16, comprising:
sending a request to Join, Leave or Revoking the at least one domain, and
receiving result information in response to the request to Join, Leave or Revoking the at least one domain, notifying the result of the Join, Leave or Revoking.

18. A method for subscribing a mobile service, comprising:
obtaining a domain ID related to a set domain;
sending a request to Join, Leave or Revoking the domain, and
receiving result information in response to the request to Join, Leave or Revoking the at least one domain, notifying the result of the Join, Leave or Revoking.

19. A system for subscribing a mobile service, comprising a Domain Setter, a domain management center and a Subscription Center, wherein
the Domain Setter is capable of sending a Set Domain Request containing Domain Setter information to the domain management center, obtaining a domain ID from a Set Domain Response received from the domain management center, and sending service subscription request information to the Subscription Center, wherein the service subscription request information contains Domain Setter information, at least one domain ID and at least one service ID of a service to be subscribed;
the domain management center comprises a domain-setting unit for verifying the Domain Setter according to the received Set Domain Request, and assigning the domain ID to the Domain Setter if the verification is passed; and
the Subscription Center is capable of receiving the service subscription request information, subscribing a service indicated by a service ID of the service to be subscribed for a domain indicated by the domain ID, setting and saving an index relation among the Domain Setter information, the domain ID and the service ID of the subscribed service, and accomplishing the subscription operation.

20. The system of claim 19, wherein after the Subscription Center receives the service subscription request information, the Subscription Center is further capable of authenticating the Domain Setter and the domain ID, and accomplishing the subscription operation after the authentication is passed.

21. The system of claim 19, wherein the domain management center further comprises a domain-revoking unit for receiving a Revoke Domain Request which contains a domain ID, verifying whether a domain to be revoked exists and whether a client that sends the Revoke Domain Request has a privilege for revoking the domain, and revoking the domain indicated by the domain ID when the domain to be revoked exists and the client that sends the Revoke Domain Request has a privilege for revoking the domain.

22. The system of claim 21, wherein the domain-revoking unit in the domain management center is further used for deleting index information related to the revoked domain.

23. The system of any one of claims 19, wherein:
the domain management center further comprises a domain-joining unit for receiving a Join Domain Request from a client-side device, the Join Domain Request containing a device ID of a device to join and a domain ID of a domain to be joined, verifying whether the domain is valid and whether the device is allowed to join, and adding the device ID of the device to join to a device list contained in the domain when the domain is valid and the device is allowed to join.

24. The system of claim 23, wherein:
the domain management center further comprises a domain-leaving unit for receiving a Leave Domain Request from the client-side device, which contains a device ID of a device to leave and a domain ID, verifying whether a domain is valid, and deleting the device ID of the device to leave from the device list contained in the domain when the domain is valid; or sending the Leave Domain Request which contains the device ID of the device to leave and the domain ID to the client-side device, and deleting the device ID of the device to leave from the device list contained in the domain after a response is received.

25. The system of claim 24, wherein the domain management center further comprises a notifying unit for notifying the Subscription Center of a joining or deleting result.

26. The system of claim 24, wherein the client-side device is the device to join/leave, a device of the Domain Setter, or other devices in the domain except for the Domain Setter; and the device to join/leave and the device of the Domain Setter are the same device or different devices.

27. The system of claim 24, wherein the domain is a device domain or a user domain.

28. The system of claim 27, wherein when the domain is the user domain, the device ID of the device to join/leave is an ID of a specific certain device or an ID of a certain device domain.

29. The system of claim 19, wherein the Subscription Center and the domain management center are on the same physical entity or on different physical entities.

30. The system of claim 19, wherein if a plurality of domain IDs and a plurality of service IDs of services to be subscribed are contained in the subscription request information, a one-to-one relation, one-to-many relation, many-to-many relation or many-to-one relation exists between the plurality of domain IDs and the plurality of service IDs of the services to be subscribed.

31. A domain management system, comprising a domain-setting unit for verifying a client according to a received Set Domain Request, and assigning a domain ID to the client after the verification is passed.

32. The domain management system of claim 31, wherein the domain management center further comprises an authentication unit for authenticating the Domain Setter and the domain ID.

33. The domain management system of claim 32, wherein the domain management center further comprises a domain-revoking unit for receiving a Revoke Domain Request which contains a domain ID, verifying whether a domain to be revoked exists and whether a client that sends the Revoke Domain Request has a privilege for revoking the domain, and revoking a domain indicated by the domain ID when a domain to be revoked exists and a client that sends the Revoke Domain Request has a privilege for revoking the domain.

34. The domain management center of claim 33, wherein the domain revoking-unit is further used for deleting index information related to the revoked domain.

35. The domain management center of any one of claims 31, wherein the domain management center further comprises a domain-joining unit for receiving a Join Domain Request from a client-side device, the Join Domain Request containing a device ID of a device to join and a domain ID of a domain to be joined, verifying whether the domain is valid and whether the device is allowed to join, and adding the device ID of the device to join to a device list contained in the domain when the domain is valid and the device is allowed to join.

36. The domain management center of claim 35, further comprising a domain-leaving unit for receiving a Leave Domain Request from a client-side device, the Leave Domain Request containing a device ID of a device to leave and a domain ID, verifying whether a domain is valid, and deleting the device ID of the device to leave from the device list contained in the domain after the verification is passed; or sending the Leave Domain Request which contains the device ID of the device to leave and the domain ID to the client-side device, and deleting the device ID of the device to leave from the device list contained in the domain after a response is received.

37. The domain management center of claim 36, wherein the domain management center further comprises a notifying unit for notifying other devices of a joining or deleting result.
